(19) United States
(12) Patent Application Publication
(10) Pub. No.: US 2025/0246883 A1
(43) Pub. Date: Jul. 31, 2025

(54) CABLE GUIDES

(71) Applicant: Milwaukee Electric Tool Corporation, Brookfield, WI (US)

(72) Inventors: Adam Schroeder, Brookfield, WI (US); Samuel Petre, Brookfield, WI (US)

(21) Appl. No.: 19/032,974

(22) Filed: Jan. 21, 2025

Related U.S. Application Data
(60) Provisional application No. 63/626,487, filed on Jan. 29, 2024.

(51) Int. Cl. H02G 1/06

(52) U.S. Cl. CPC H02G 1/06

(57) ABSTRACT

A cable guide can include a body with a first body portion and a second body portion defining a central opening to receive and guide a cable arranged through the central opening, a hinge arranged at a first end of the body to pivotally secure the first body portion to the second body portion, and an arcuate surface forming a lead-in radius circumferentially surrounding the opening, the arcuate surface extending from a first side of the body towards the central opening.

### CROSS-REFERENCE TO RELATED APPLICATIONS

This application claims the benefit of U.S. Provisional Application No. 63/626,487, filed Jan. 29, 2024, which is hereby incorporated by reference in its entirety.

### BACKGROUND

In construction applications, an operator may need to run (e.g., pull) metal clad (MC) or armor clad (AC) cable through studs, walls, trusses, or other components of a structure. However, in some examples, an external sheath of the cable (e.g., surrounding the conductors of the MC/AC cable), may snag on the studs during installation, which may make installation of the cable difficult and decrease overall installation efficiency.

### SUMMARY

Some aspects of the disclosure provide a cable guide. The cable guide can include a body with a first body portion and a second body portion defining a central opening to receive and guide a cable arranged through the central opening, a hinge arranged at a first end of the body to pivotally secure the first body portion to the second body portion, and an arcuate surface forming a lead-in radius circumferentially surrounding the opening, the arcuate surface extending from a first side of the body towards the central opening.

Some aspects of the disclosure provide a method of installing a cable guide within a stud. The method can include providing a cable guide with a body having a first body portion and a second body portion together defining a central opening, an arcuate surface extending from a first side of the body toward the central opening to form a lead-in radius circumferentially surrounding the opening, and a bushing on a second side of the body, the bushing projecting from the second side of the body and circumferentially surrounding the opening, arranging the bushing through an opening in the stud so that the bushing overlaps an edge of the opening in the stud, and guiding a cable through the central opening of the cable guide, the arcuate surface providing a snag-free surface for the cable during installation of the cable.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1A is an axonometric view of one example of a cable guide according to aspects of the present disclosure in a closed position.

FIG. 1B is a perspective view of a stud including a cable for use with the cable guide of FIG. 1A.

FIG. 2 is a perspective view of the cable guide of FIG. 1A in an open position.

FIG. 3 is a first cross-sectional view of the cable guide of FIG. 1A.

FIG. 4 is an axonometric view of a first portion of a body of the cable guide of FIG. 1A.

FIG. 5 is an axonometric view of a second portion of the body of the cable guide of FIG. 1A.

FIG. 6 is a second cross-sectional view of the cable guide of FIG. 1A.

FIG. 7 is a perspective view of a first stage in an installation process of the cable guide of FIG. 1A on the stud of FIG. 1B.

FIG. 8 is a perspective view of a second stage in the installation process of the cable guide of FIG. 1A on the stud of FIG. 1B.

FIG. 9 is an axonometric view of another example of a cable guide according to aspects of the present disclosure.

FIG. 10 is a side view the cable guide of FIG. 9.

FIG. 11 is a cross-sectional view of the cable guide of FIG. 9.

FIG. 12 is an axonometric view of a first portion of a body of the cable guide of FIG. 9.

FIG. 13 is an axonometric view of a second portion of the body of the cable guide of FIG. 9.

FIG. 14 is an axonometric view of another example of a cable guide for use with the stud including the cable of FIG. 1B according to aspects of the present disclosure.

FIG. 15 is a perspective view of the cable guide of FIG. 14 in an installed configuration.

FIG. 16 is an axonometric view of another example of a cable guide for use with the stud including the cable of FIG. 1B according to aspects of the present disclosure.

FIG. 17 is a front view of the cable guide of FIG. 16.

FIG. 18 is a perspective view of the cable guide of FIG. 16 in an installed configuration.

FIG. 19 is a first axonometric view of another example of a cable guide for use with the stud including the cable of FIG. 1B according to aspects of the present disclosure.

FIG. 20 is a second axonometric view of the cable guide of FIG. 19.

FIG. 21 is a side view of the cable guide of FIG. 19.

FIG. 22 is a perspective view of the cable guide of FIG. 19 in an installed configuration.

### DETAILED DESCRIPTION

The following discussion is presented to enable a person skilled in the art to make and use embodiments of the invention. Given the benefit of this disclosure, various modifications to the illustrated embodiments will be readily apparent to those skilled in the art, and the principles herein can be applied to other embodiments and applications without departing from embodiments of the invention. Thus, embodiments of the invention are not intended to be limited to embodiments shown, but are to be accorded the widest scope consistent with the principles and features disclosed herein.

As generally noted above, installing cable (e.g., MC/AC cable) may be a labor-intensive process that requires a user to manually unsnag the cable multiple times during the installation process. As should be appreciated, this process may be time-consuming and inefficient, which is undesirable in many construction application.

To mitigate these issues, the operator may utilize one or more cable guides. The cable guides may be installed prior to installation of the cable, during installation of the cable, or even after installation of the cable. Thus, the operator may determine potential snag-prone areas and install the cable guide as needed to reduce the risk of snagging and simplify the installation process. For example, the operator may install the cable guides at elevation changes, stud entrance/exit locations, or corners.

In some examples, the cable guide may include a clamshell type body defining a central opening, with first and second portions of the body rotateably secured together via a hinge. Thus, an operator may rotate the first and second portions of the body relative to each other to move the cable guide between an open position and a closed position, depending on the installation method needed. Further, the cable guide may include an arcuate surface leading into the opening. The arcuate surface may define an arc length that is greater than a size (e.g., width) of the grooves in an exterior sheath of the cable. Thus, the grooves of the cable may be unable to snag on the cable guide, which may facilitate case of installation of the cable.

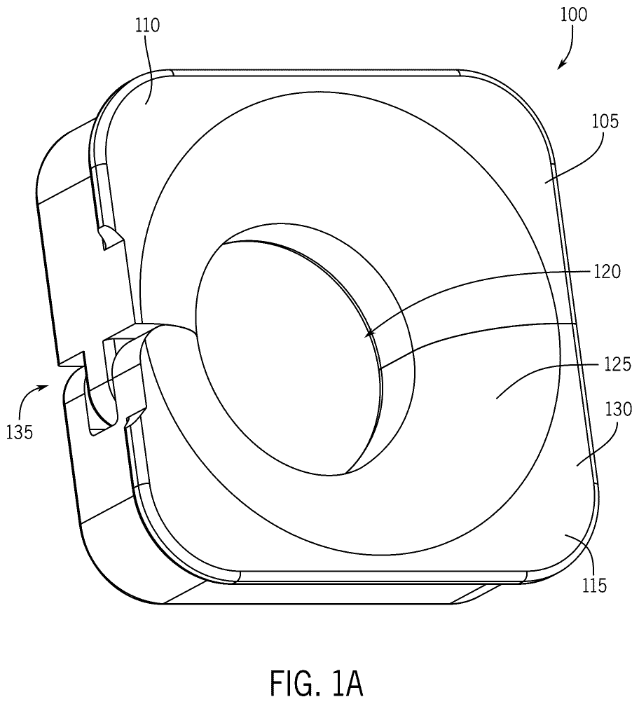

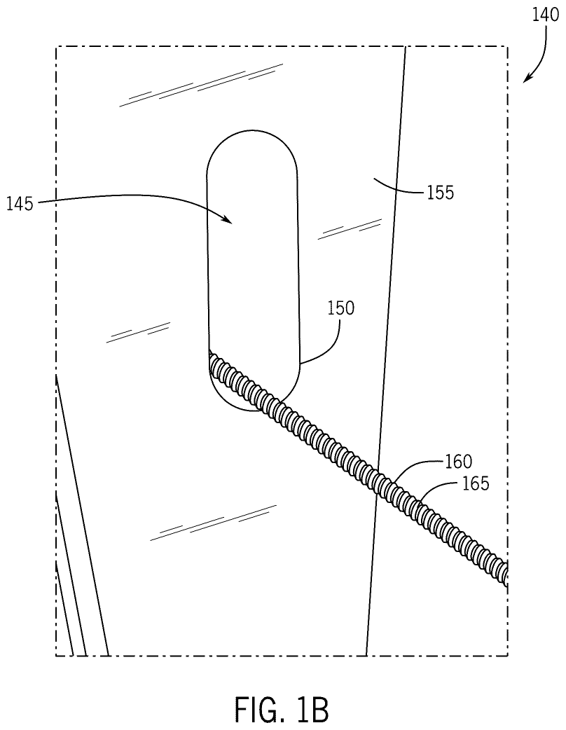

FIG. 1A shows an example of a cable guide 100 for use in guiding cable (e.g., armor clad (AC) or metal clad (MC) cable) through studs, walls, trusses, or other components of a structure during installation of the cable. In some examples, the cable guide 100 may be a reusable component, which may be installed by an operator prior to or during installation of the cable. Correspondingly, once the cable has been installed the operator may remove the cable guide 100 for later use (e.g., at another location). Further, in some examples, the cable guide 100 may be selectively positioned by an operator at particularly snag prone areas (e.g., at corners, cable entrance/exit locations, elevation changes, etc.) to reduce the risk of snagging the cable during installation, which may make installation difficult.

In some examples, as shown in FIG. 1B, the cable guide 100 may be used in to facilitate the installation of armor clad (AC) or metal clad (MC) cable 160, which may include an exterior sheath 165 defining a spiral groove pattern. However, without the use of the cable guide 100, the exterior sheath 165 of the cable 160 may snag on an edge 150 of an opening 145 in a stud 140 (e.g., a metal stud). Thus, during installation of the cable 160, the operator may have to constantly adjust the cable 160 to reduce snagging, which can be time consuming. However, via the use of the cable guide 100, the risk of the exterior sheath 165 snagging may be reduced, which may make installation of the cable 160 faster and less cumbersome for an operator. As should be appreciated, in other examples, the cable guide 100 may be used with other types of cable (e.g., ethernet, non-metallic sheathed (NM), data, underground feeder (UF), audio & video, tubing, corrugated tubing, or any other known type of cable). Further, the cable guide 100 may be used with other structural components besides a stud (e.g., truss, purlin, walls, or other structural components).

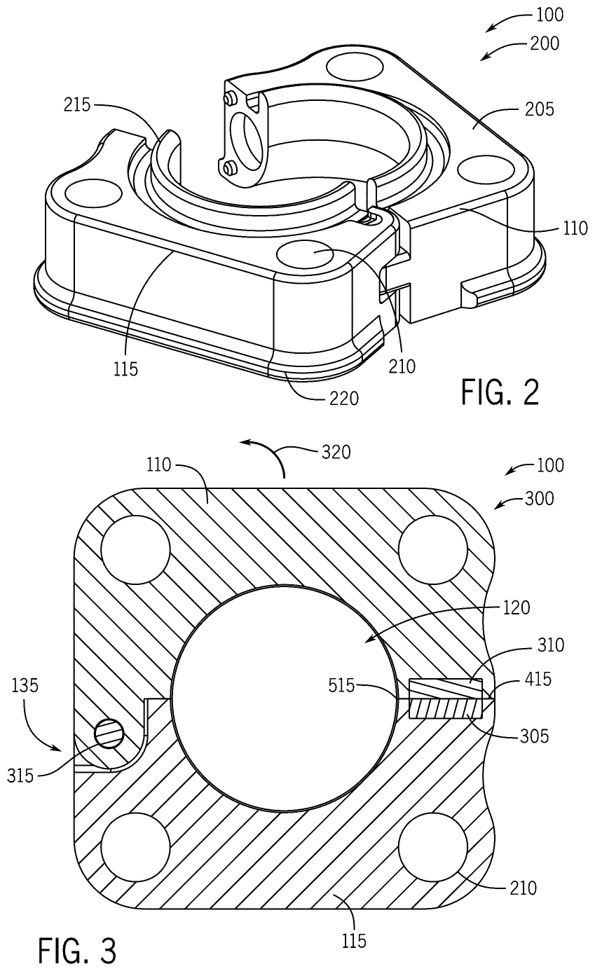

With reference to FIG. 1A, the cable guide 100 may include a body 105 having a first clamshell portion 110 and a second clamshell portion 115. In some examples, the first portion 110 and the second portion 115 may be pivotable relative to each other (e.g., via a hinge 135) to move the cable guide 100 between a first, closed configuration 300 (see, e.g., FIG. 3) and a second, open configuration 200 (see, e.g., FIG. 2). In some examples, the body 105 may include a central opening 120 extending through the body and configured to receive and retain one or more cables 160. For example, the central opening 120 may be sized to permit the insertion of five (5) 12-3 sized MC/AC cables through the opening 120. In some examples, the opening 120 may define a circular shape. However, in other examples, the opening 120 may define other shapes (e.g., ovular, rectangular, etc.). Correspondingly, in some examples, the body 105 may define a substantially rectangular outer perimeter. However, in other examples, the outer perimeter of the body 105 may be other shapes (e.g., circular, ovular, U-shaped, C-shaped, etc.).

In some examples, to mitigate the risk of the exterior sheath 165 snagging, the cable guide 100 may include an extended arcuate surface 125 (e.g., a lead-in radius) circumferentially surrounding the opening 120. In some examples, the arcuate surface may be a smooth, unbroken surface with an arc length greater than a corresponding spacing between grooves of the exterior sheath 165. Thus, the grooves in the exterior sheath 165 of the cable 160 may be unable to snag on the arcuate surface 125. In some examples, the arcuate surface 125 may extend from a first side 130 of the cable guide 100 to the opening 120. Thus, regardless of the rotational position of the cable guide 100 on the stud 140 any cable 160 arranged within the opening 120 may contact the arcuate surface 125.

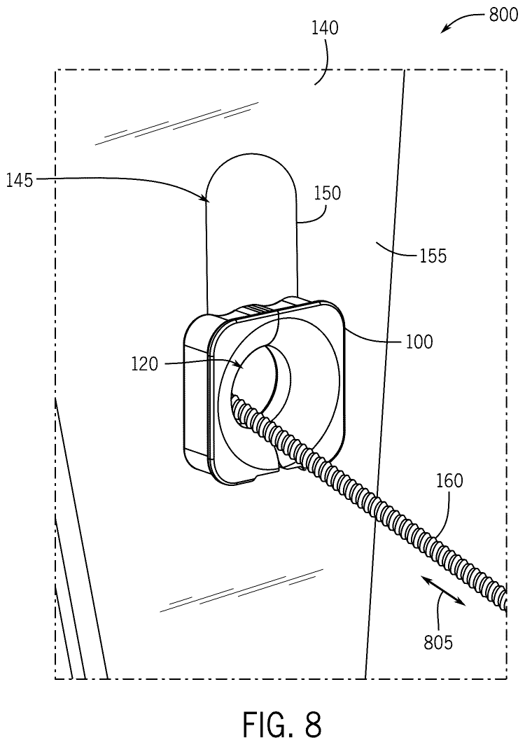

With reference to FIG. 2, opposite the first side 130, a second side 205 of the cable guide 100 may include one or more magnets 210. In some examples, when in an installed configuration (see, e.g., FIG. 8), the second side 205 of the cable guide 100 may contact a surface 155 of the stud 140 (e.g., a metal stud). Thus, the magnets 210 may assist in securing the cable guide 100 to the stud 140 (e.g., by magnetically fixing the cable guide 100 to the stud 140). In some examples, to provide purchase (e.g., grip) to an operator attempting to remove the cable guide 100 from the stud 140, the cable guide 100 may include a lip 220 protruding around the outer perimeter of the cable guide 100. Further, the body 105 of the cable guide 100 may include a textured surface (e.g., including stippling, ridges, or other textural elements).

In some examples, to further mitigate the risk of the exterior sheath 165 of the cable 160 snagging on the edge 150 of the opening 145 in the stud 140, the cable guide 100 may include a bushing 215. The bushing 215 may extend from the second side 205 of the cable guide 100 and protrude past (e.g., beyond) a surface of the second side 205 of the cable guide. Thus, when the cable guide 100 is installed within the opening 145 of the stud 140, the bushing 215 may cover (e.g., overlap) the edge 150 of the opening 145 to mitigate the risk of the cable 160 snagging on the edge 150. In other examples, the bushing 215 may assist in aligning the cable guide 100 with the opening 145 during installation of the cable guide 100. For example, the operator may slot the bushing into the opening 145 in the stud 140. Further, in some examples, the cable guide 100 may include one or more different sized bushings 215, which may be configured to match the size of the opening 145 in the stud 140.

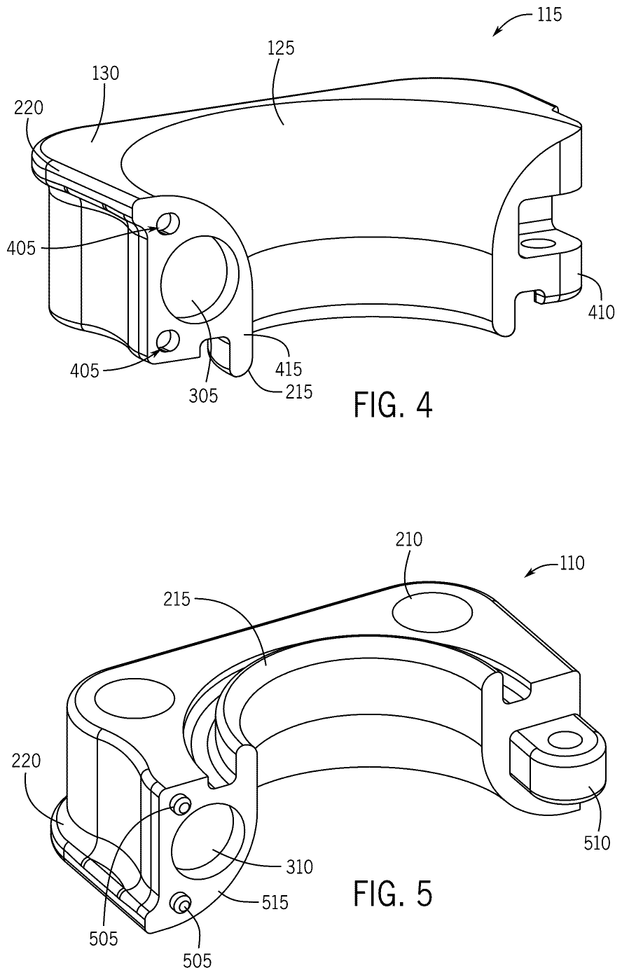

Looking at FIGS. 3-5, as mentioned previously, first portion 110 and the second portion 115 of the body may rotate relative to each other as shown by arrow 320 (e.g., between open and closed configurations) via the hinge 135. In some examples, the hinge 135 may include a male portion 510 and a female portion 410 secured together via a pin 315. In some examples, the pin 315 may form an axis about which the first and second portions 110, 115 of the body may rotate (e.g., as shown by arrow 320).

In some examples, when in a first, closed configuration 300, a first end 515 of the first portion 110 and a second end 415 of the second portion 115 may be in contact (e.g., as shown in FIG. 3). Put differently, a perimeter of the cable guide 100 (e.g., surrounding the opening 120) may be closed (e.g., unbroken). In some examples, to maintain the cable guide 100 in the closed configuration 300, the cable guide 100 may include a pair of magnets 305, 310 arranged in the first and second ends 415, 515 of the cable guide 100. In some examples, the magnets 305, 310 may generate a magnetic force to maintain the cable guide 100 in the closed configuration 300. Further, in some examples, to maintain alignment of the first and second portions 110, 115 of the body (or the magnets 305, 310), the first end 515 may include a pair of protrusions 505 configured to nest within a corresponding pair of apertures 405 in the second end 415. For example, when the cable guide 100 is in the closed configuration 300, the protrusions 505 may nest within the apertures 405.

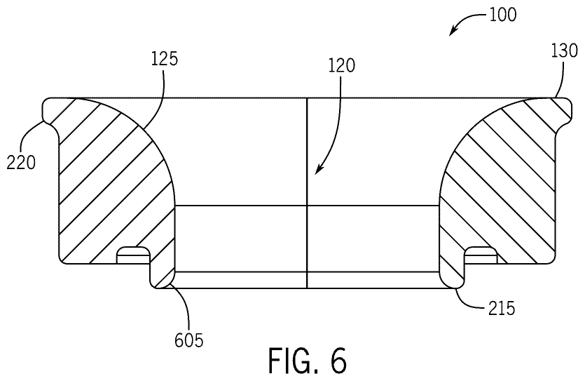

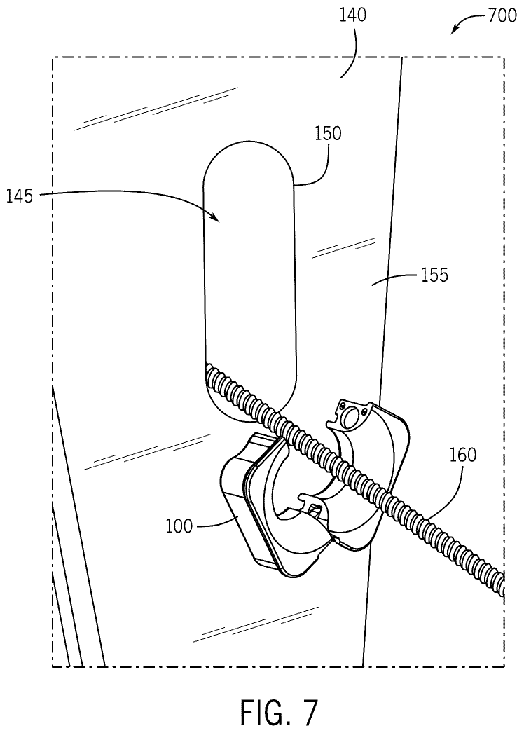

FIGS. 6-8 show an example of an installation process of the cable guide 100. For example, at a first stage 700 in the installation process, an operator may move the cable guide 100 into the open configuration 200. In some examples, moving the cable guide 100 into the open configuration 200 may permit the operator to insert the cable guide 100 in locations prone to cable snagging (e.g., around corners, elevation changes, entering/exiting studs, etc.). Further, by moving the cable guide 100 into the open configuration 200, the operator may be able to install the cable guide even when the cable 160 is already installed through the opening 145 in the stud 140. However, as should be appreciated, in other examples, the operator may choose to install the cable guide 100 prior to installation of any of the cable 160. In this case, the operator may install the cable guide 100 while still in the closed configuration 300.

In some examples, at a second stage 800 in the installation process, the operator may position the cable 160 within the opening 120 of the cable guide 100. Following this, the operator may move the cable guide 100 into the closed configuration 300. In some examples, once the cable 160 is arranged within the opening 120 of the cable guide 100, the operator may insert the bushing 215 of the cable guide 100 with the opening 145, so that the bushing 215 overlaps the edge 150 of the opening 145. Correspondingly, the second side 205 of the cable guide 100 may contact the surface 155 of the stud 140, so that the magnets 210 secure the cable guide 100 to the stud 140.

In some examples, once the cable guide 100 is installed, the operator may install the cable 160 without snagging. For example, the cable 160 may move (e.g., slide) along the arcuate surface 125 of the cable guide 100. In some examples, to permit multidirectional (e.g., backwards, and forwards) movement of the cable 160 (e.g., in the directions shown by arrow 805), the bushing 215 may include a radiused edge 605 (e.g., a second radius), which may permit slidable movement of the cable 160 without snagging.

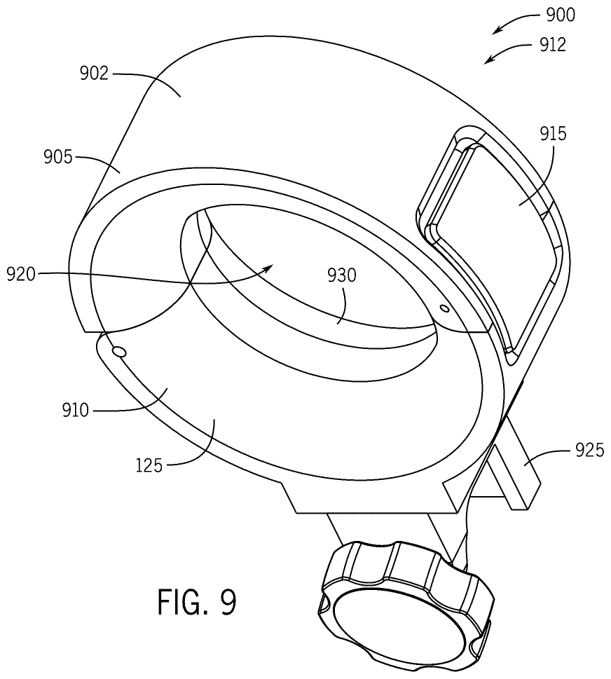

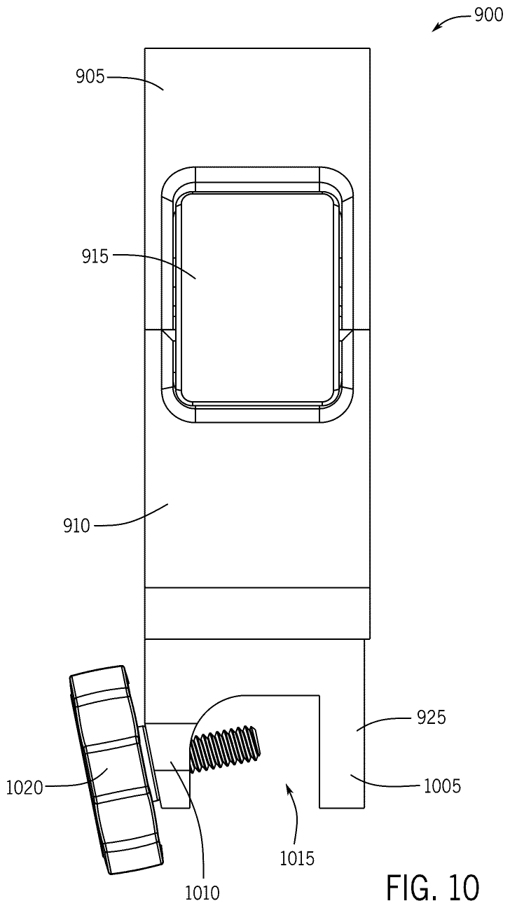

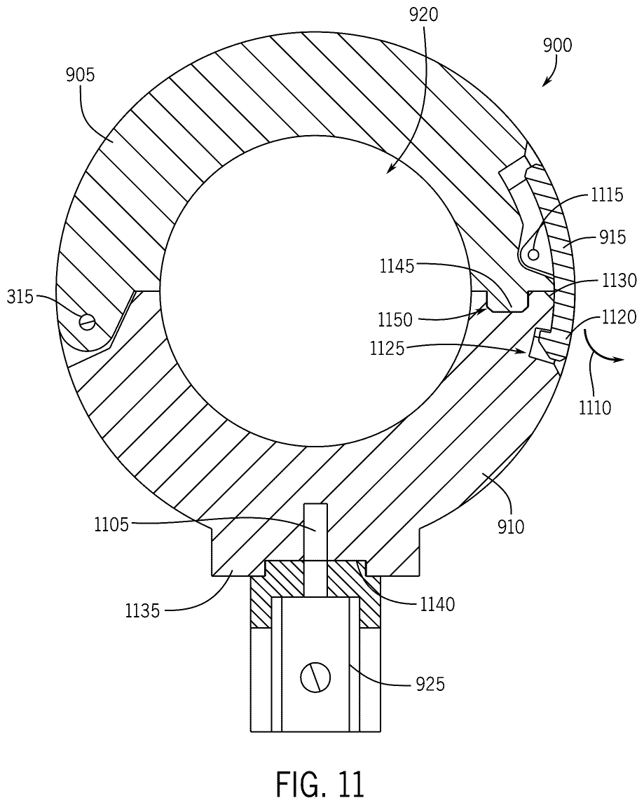

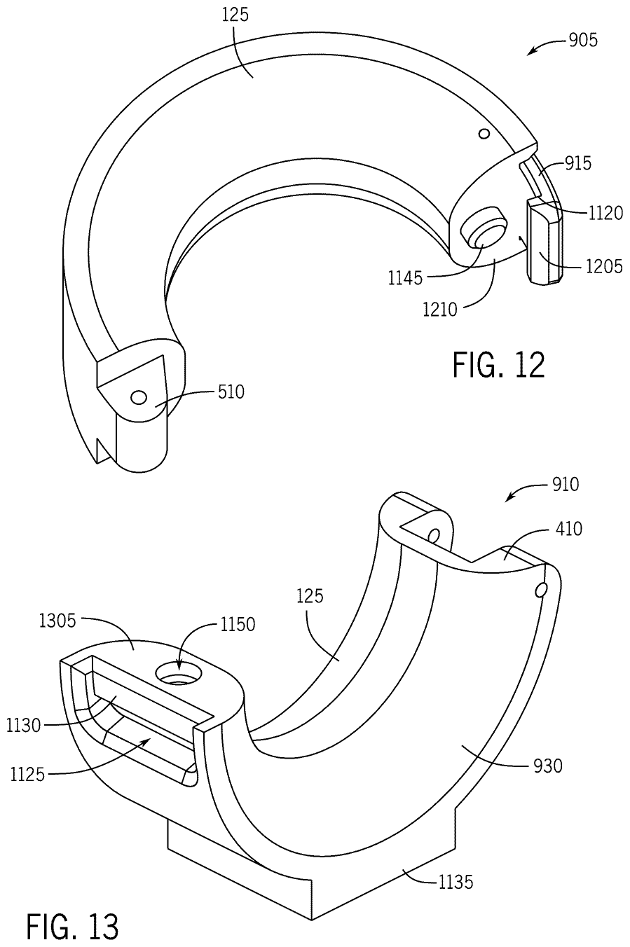

FIGS. 9-13 illustrate another example of a cable guide 900 that can be used to guide cable (e.g., as an alternative configuration of the cable guide 100). As will be recognized, the cable guide 900 shares a number of components in common with and operates in a similar fashion to the examples illustrated and described previously. For the sake of brevity, these common features will not be again described below in detail. Rather, previous discussion of similarly named or numbered features, unless otherwise indicated, also applies to example configurations of the cable guide 900.

In some examples, the cable guide 900 may be particularly well suited for use in guiding cable (e.g., MC/AC cable) along one or more overhead components (e.g., purlins, trusses, etc.). Thus, in some examples, the cable guide 900 may include a mounting system 925. The mounting system 925 may facilitate the mounting (e.g., removable mounting) of the cable guide 900 to a purlin, truss, or other structural component. In some examples, the mounting system 925 may include a pair of legs 1005, 1010, which extend from a pedestal 1140 and together define a cutout 1015 configured to receive a portion (e.g., edge, etc.) of the purlin, truss, or other structural component.

In some examples, a portion of the cable guide (e.g., a mounting flange) may connect to the pedestal 1140 via a clocking feature (e.g. an octagonal protrusion and corresponding aperture). As a result, the cable guide may be rotated with respect to the mounting system to permit the pulling of cable at different angles with respect to the structural component. For example, the cable guide may be rotated to permit an operator to pull along (e.g., parallel to) a purlin, perpendicular to a purlin, at a 45 degree angle relative to the purlin, or at any other desired angle relative to the purlin (or other structural component). In some examples, the pedestal 1140 may nest within a mounting flange 1135 of the cable guide 900 (see, e.g., FIG. 11) and secure the mounting system 925 to the cable guide via a fastener (e.g., screw, bolt, nut, clamp, or any other known fastener) arranged through the pedestal 1140 and into the mounting flange 1135.

In some examples, in order to secure the cable guide 900 to the purlin, truss, or other structural component via the mounting system 925, a portion of the structural component may first be arranged within the cutout 1015. Following this, an operator may adjust (e.g., tighten) a set screw 1020 (e.g., a threaded or other removable fastener) arranged through the leg 1010 so that an end of the set screw 1020 abuts the structural component. Correspondingly, to remove the cable guide 900 from the structural component, the operator may adjust (e.g., loosen) the set screw 1020 so that the end of the set screw 1020 loses contact with the structural component. Following this, the operator may remove the structural component from the cutout 1015 and remove the cable guide 900.

With reference to FIG. 9, similar to the cable guide 100, the cable guide 900 may include a body 902 with first and second clamshell portions 905, 910. In some examples, the first and second portions 905, 910 may be rotatable relative to each other to move the cable guide 900 between open and closed positions (e.g., as discussed previously). In some examples, in addition to the arcuate surface 125 on the first side of the cable guide, the cable guide 900 may include a second arcuate surface 930 on the second, opposite side of the cable guide. Thus, the cable 160 may be passed through an opening 920 of the cable guide in either direction (e.g., from the first side or the second side). In some examples, both of the arcuate surfaces 125, 930 may have the same arc length. However, in other examples, the arc length of the first and second acuate surface 125, 930 may be different.

In some examples, in order to secure the cable guide 900 in a closed configuration 912, the cable guide 900 may include a latch 915. The latch 915 may be pivotally secured to the first portion 905 of the cable guide 900 via a pin 1115 to permit movement of the latch between a locked and an unlocked position. In some examples, a biasing element (e.g., a spring) may surround the pin 1115 and bias the latch 915 into the locked position (sec, e.g., FIG. 11). In the locked position, a ledge 1120 of the latch 915 may engage (e.g., snap) into a corresponding groove 1125 of the second portion 910. Thus, when the cable guide 900 is in the closed configuration 912, the latch 915 may snap into the groove 1125 and secure the first and second portions together (e.g., into the closed configuration 912).

In some examples, a first end of the latch 915 may include a chamfered edge 1205. The chamfered edge 1205 may be configured to contact an edge 1130 of the second portion when moving the cable guide 900 into the closed configuration 912. In some examples, contact between the edge 1205 and the edge 1130 may apply a force to the latch 915 in the direction shown by arrow 1110 (e.g., against a biasing force provided by the biasing element). However, due to the biasing force provided by the biasing element, the ledge 1120 may be biased into engagement with the groove 1125 (e.g., snap into the groove 1125) once the ledge 1120 moves past the edge 1130. Further, in some examples, to unlock relative movement between the first and second portion 905, 910, an operator may apply a force to a second end of the latch 915, which may move the first end of the latch (e.g., including the ledge) in the direction shown by arrow 1110 to move the ledge 1120 out of the groove 1125 and permit the operator to move the cable guide 900 into the open configuration.

In some examples, to maintain alignment of the first and second portions 905, 910 of the cable guide 900, an end 1210 of the first portion 905 may include a protrusion 1145. Correspondingly, an end 1305 of the second portion 910 may include an aperture 1150. Thus, in some examples, the protrusion 1145 may be configured to nest with the aperture 1150 when the cable guide 900 is in the closed configuration. In some examples, instead of utilizing the protrusion 1145 and the aperture 1150, the cable guide 900 may instead utilize one or more magnets arranged in respective ends 1210, 1305 of the first and second portions 905, 910.

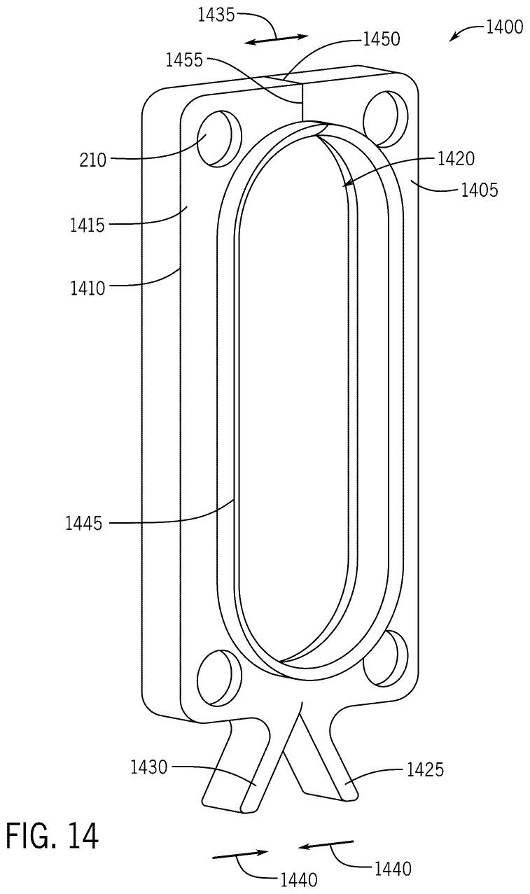

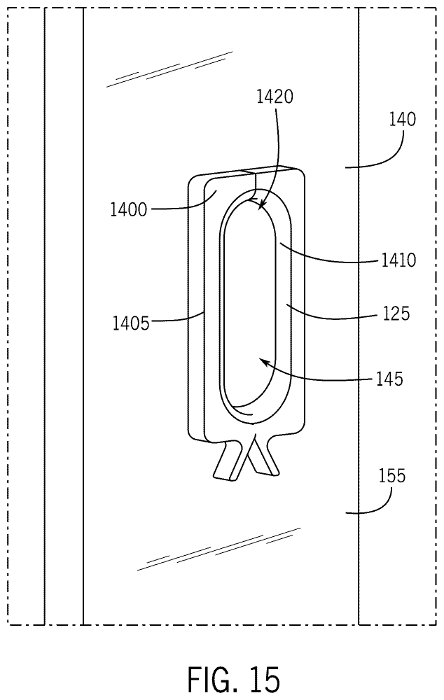

FIGS. 14 and 15 illustrate another example of a cable guide 1400 that can be used to guide cable (e.g., as an alternative configuration of the cable guides 100, 900). As will be recognized, the cable guide 1400 shares a number of components in common with and operates in a similar fashion to the examples illustrated and described previously. For the sake of brevity, these common features will not be again described below in detail. Rather, previous discussion of similarly named or numbered features, unless otherwise indicated, also applies to example configurations of the cable guide 1400.

In some examples, the cable guide 1400 may include a pair of hinged arms 1405, 1410, together defining an opening 1420. In some examples, the opening 1420 may be ovular in shape and configured to receive and guide the cable 160. Correspondingly, in some examples, a bushing 1445 may surround (e.g., circumferentially surround) the opening and extend away from a second side 1415 of the cable guide 1400. In some examples, the bushing 1445 may be configured to nest within the opening 145 of the stud 140 (e.g., to cover the edge 150). In some cases, in order to secure the cable guide 1400 to the stud 140 (e.g., a metal stud), the cable guide 1400 may include magnets 210 arranged on the second side 1415 of the cable guide. Thus, when the cable guide 1400 is installed into the stud 140 (sec, e.g., FIG. 15), the second side 1415 of the cable guide 1400 may contact the stud 140 so that the magnets 210 may secure the cable guide 1400 to the stud 140.

In some examples, the cable guide 1400 may include pair of tabs (e.g., a first tab 1425 and a second tab 1430) extending away from a first end of the arms 1405, 1410. The tabs 1425, 1430 may permit an operator to move the cable guide 1400 into the open position. For example, to move the cable guide into the open position, the operator may move the tabs towards each other (e.g., as shown by arrows 1440). In some examples, as the tabs 1425, 1430 are moved towards each other, opposing ends 1450, 1455 of the arms 1405, 1410 may move away from each other (e.g., as shown by arrows 1435) to form a break in the perimeter defined by the cable guide 1400. In other examples, a biasing element (e.g., a spring) may be arranged between the tabs 1425, 1430 so that, when an operator releases the tabs, the cable guide 1400 may automatically return to the closed configuration.

In some examples, the cable guide 1400 may be positioned on a stud 140 even when the cable 160 is already installed within the opening 145. For example, an operator may begin installing cable through the stud, encounter a snag (e.g., due to an elevation change, corner, etc.), and then install the cable guide 1400.

In some examples, to install the cable guide 1400 when the cable 160 is already within the opening 145, the operator may pinch the tabs 1425, 1430 towards each other to move the cable guide into the open configuration. Following this, the operator may arrange the cable 160 with the opening 1420 of the cable guide and then release the tabs to permit the cable guide to return to the closed configuration. Following this, the operator may arrange the bushing 1445 within the opening 145 in the stud 140. In some examples, when the bushing 1445 is arranged within the opening of the stud, the magnets 210 may secure the cable guide to the stud 140. In some examples, when the cable 160 is not already within the opening 145, the operator may simply install the cable guide 1400 when in the closed configuration (e.g., without needed to utilize the tabs 1425, 1430). Further, to remove the cable 160 from within the opening of the cable guide 1400, the operator may pinch the tabs 1425, 1430 to move the cable guide into the open configuration. Following this, the operator may pass the cable 160 through a gap formed between the ends of the arms 1405, 1410.

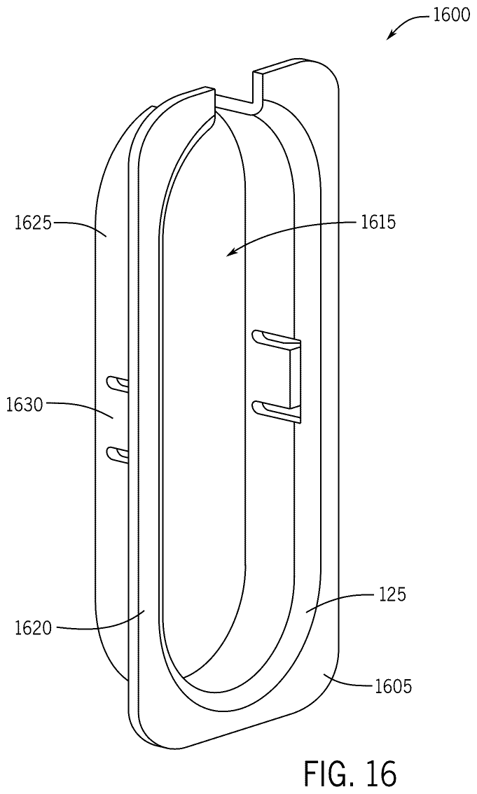

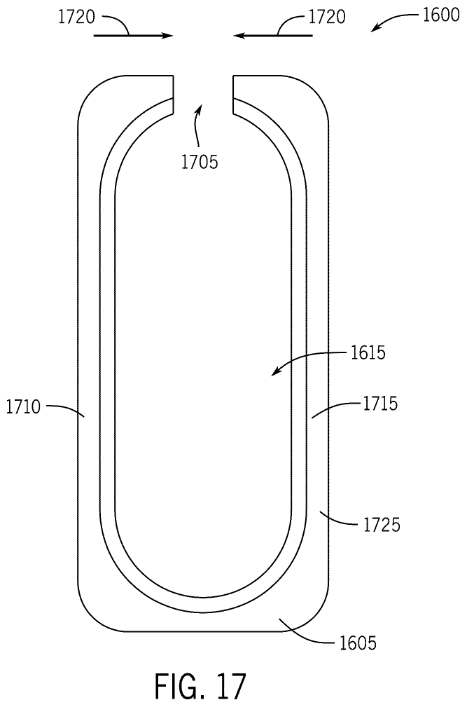

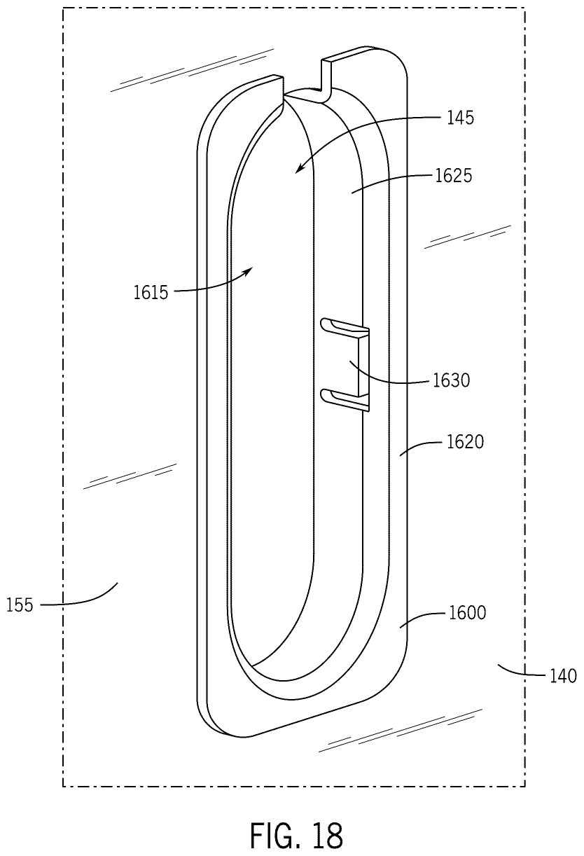

FIGS. 16-18 illustrate another example of a cable guide 1600 that can be used to guide cable (e.g., as an alternative configuration of the cable guides 100, 900, 1400). As will be recognized, the cable guide 1600 shares a number of components in common with and operates in a similar fashion to the examples illustrated and described previously. For the sake of brevity, these common features will not be again described below in detail. Rather, previous discussion of similarly named or numbered features, unless otherwise indicated, also applies to example configurations of the cable guide 1600.

In some examples, the cable guide 1600 may include a U-shaped body 1605 with a cutout 1705 at a first end of the body. In some examples, cutout may be defined between a pair of resilient arms 1710, 1715. The cutout 1705 may permit insertion of the cable 160 through the cutout and into an opening 1615 of the cable guide, without needing to move the cable guide 1600 between open and closed configurations.

Thus, to install and remove the cable guide 1600, an operator may grasp the cable guide and apply a force in the direction shown by arrows 1720 to elastically deform the arms 1710, 1715 (e.g., move the arms 1710, 1715 towards each other). Following this, the operator may insert a mounting flange 1625 of the cable guide into the opening 145 of the stud 140 until a second side 1620 of a rim 1725 of the cable guide 1600 contacts the surface 155 of the stud 140. In some examples, once the second side 1620 contacts the surface of the stud 140, the operator may release the cable guide 1600 so that the locking tabs 1630 snap around the edge 150 of the stud 140 and lock the cable guide 1600 into position. In some examples, to remove the cable guide 1600 from the opening 145, the operator may apply a force in the direction shown by arrows 1720 to separate the locking tabs 1630 from the edge 150 of the opening of the stud 140. Following this, the operator may pass the cable 160 through the cutout 1705 formed between the ends of the arms 1710, 1715. In some examples, when a cable is installed prior to installation of the cable guide 1600, the operator may guide the cable through the cutout 1705 of the cable guide 1600 and into the opening 1615 during installation of the cable guide.

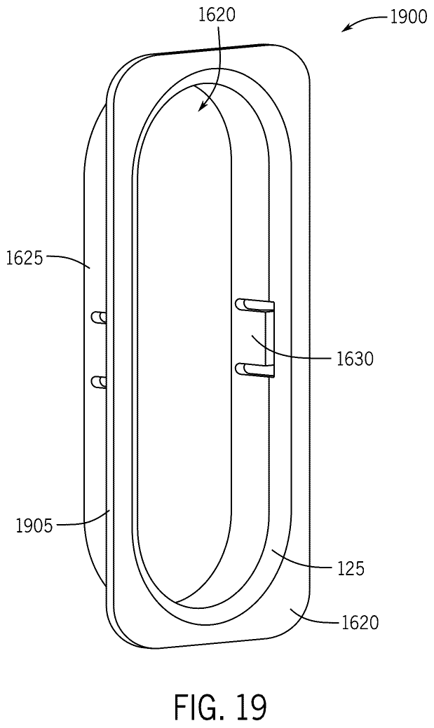

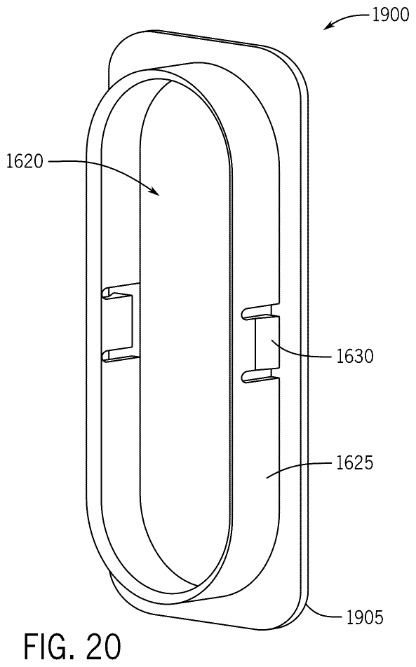

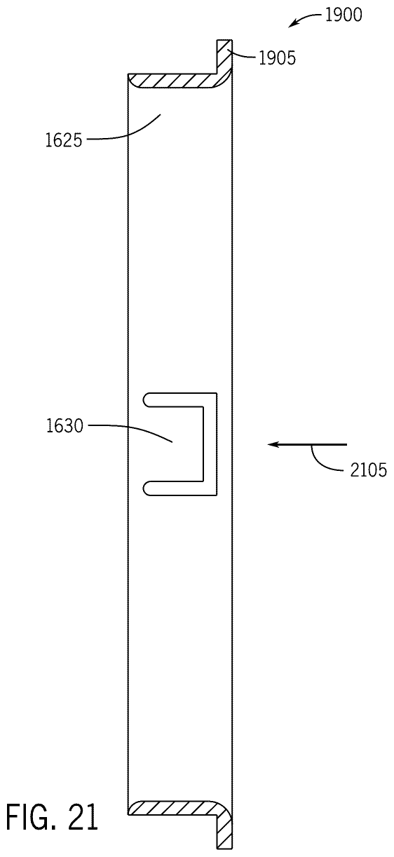

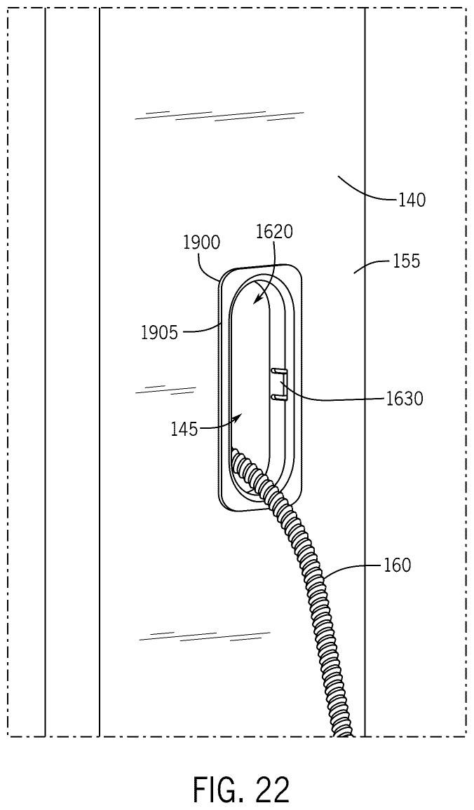

FIGS. 19-22 illustrate another example of a cable guide 1900 that can be used to guide cable (e.g., as an alternative configuration of the cable guides 100, 900, 1400, 1600). As will be recognized, the cable guide 1900 shares a number of components in common with and operates in a similar fashion to the examples illustrated and described previously. For the sake of brevity, these common features will not be again described below in detail. Rather, previous discussion of similarly named or numbered features, unless otherwise indicated, also applies to example configurations of the cable guide 1900.

In some examples, the cable guide 1900 may be similar to the cable guide 1600 discussed previously. However, the cable guide 1900 may include a solid, unbroken perimeter formed by a body 1905 (e.g., without a cutout). Thus, to install the cable guide 1900, an operator may align the mounting flange 1625 with the opening 145 in the stud 140. Following this, the operator may apply a force to the cable guide 1900 in the direction shown by arrow 2105 until the locking tabs 1630 engage (e.g., snap) around the edge 150 of the opening 145. In some examples, engagement between the locking tabs 1630 and the edge 150 may correspond to contact between the second side 1620 of the rim and the surface 155 of the stud 140. In some examples, the cable guide 1900 may be designed as a single-use product, with the cable guide 1900 designed to be left within the stud following completion of the cable installation.

In some implementations, devices or systems disclosed herein can be utilized, manufactured, or installed using methods embodying aspects of the invention. Correspondingly, any description herein of particular features, capabilities, or intended purposes of a device or system is generally intended to include disclosure of a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations.

Also as used herein, unless otherwise limited or defined, “substantially parallel” indicates a direction that is within ±12 degrees of a reference direction (e.g., within ±6 degrees), inclusive.

Also as used herein, unless otherwise limited or defined, “substantially perpendicular” indicates a direction that is within ±12 degrees of perpendicular a reference direction (e.g., within ±6 degrees), inclusive.

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

Additionally, unless otherwise specified or limited, the terms “about” and “approximately,” as used herein with respect to a reference value, refer to variations from the reference value of ±15% or less, inclusive of the endpoints of the range. Similarly, the term “substantially equal” (and the like) as used herein with respect to a reference value refers to variations from the reference value of less than ±10%, inclusive. Where specified, “substantially” can indicate in particular a variation in one numerical direction relative to a reference value. For example, “substantially less” than a reference value (and the like) indicates a value that is reduced from the reference value by 10% or more, and “substantially more” than a reference value (and the like) indicates a value that is increased from the reference value by 10% or more.

Also as used herein, unless otherwise limited or specified, “substantially identical” refers to two or more components or systems that are manufactured or used according to the same process and specification, with variation between the components or systems that are within the limitations of acceptable tolerances for the relevant process and specification. For example, two components can be considered to be substantially identical if the components are manufactured according to the same standardized manufacturing steps, with the same materials, and within the same acceptable dimensional tolerances (e.g., as specified for a particular process or product).

Unless otherwise specifically indicated, ordinal numbers are used herein for convenience of reference, based generally on the order in which particular components are presented in the relevant part of the disclosure. In this regard, for example, designations such as “first,” “second,” etc., generally indicate only the order in which a thus-labeled component is introduced for discussion and generally do not indicate or require a particular spatial, functional, temporal, or structural primacy or order.

The above detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

It is to be understood that the invention is not limited in its application to the details of construction and the arrangement of components set forth in the above description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The previous description of the disclosed embodiments is provided to enable any person skilled in the art to make or use the invention. Given the benefit of this disclosure, various modifications to these embodiments will be readily apparent to those skilled in the art, and the principles defined herein may be applied to other embodiments without departing from the spirit or scope of the invention. Thus, the invention is not intended to be limited to the embodiments shown herein but is to be accorded the widest scope consistent with the principles and novel features disclosed herein.

1. A cable guide, comprising:
a body with a first body portion and a second body portion; the body defining a central opening to receive and guide a cable arranged through the central opening;
a hinge arranged at a first end of the body, the hinge pivotally securing the first body portion to the second body portion; and
an arcuate surface forming a lead-in radius circumferentially surrounding the opening, the arcuate surface extending from a first side of the body towards the central opening.

2. The cable guide of claim 1, wherein the cable guide is configured to be installed on a structural component of a building.

3. The cable guide of claim 2, wherein the structural component is a metallic stud.

4. The cable guide of claim 1, wherein the cable is metal clad (MC) or armor clad (AC) cable having an exterior sheath defining a spiral groove.

5. The cable guide of claim 4, wherein the arcuate surface has an arc length that is greater than a width of a spiral groove in the exterior sheath of the cable.

6. The cable guide of claim 3, further comprising:
a second side of the body opposite the first side; and
one or more magnets arranged within the second side of the body, the magnets to secure the cable guide to the stud.

7. The cable guide of claim 6, further comprising:
a bushing extending from the second side of the body and circumferentially surrounding the opening, the bushing extending beyond the second side of the body.

8. The cable guide of claim 7, wherein the bushing is configured to nest within an opening in the stud, with the bushing overlapping an edge of the opening in the stud.

9. The cable guide of claim 1, wherein the cable guide is moveable between a closed configuration and an open configuration via movement of the first body portion and the second body portion about the hinge.

10. The cable guide of claim 9, wherein, in the closed configuration, a perimeter of the cable guide defined by the first body portion and the second body portion is unbroken to restrict access to the central opening via a split formed between the first body portion and the second body portion at a second end of the body.

11. The cable guide of claim 10, wherein, in the open configuration, the perimeter of the cable guide is broken to permit access to the central opening via the split between the first body portion and the second body portion.

12. The cable guide of claim 9, wherein the first body portion and the second body portion each include a magnet to secure the cable guide in the closed configuration.

13. The cable guide of claim 12, wherein the first body portion includes a protrusion configured to nest within a corresponding aperture in the second body portion when the cable guide is in the closed configuration.

14. The cable guide of claim 9, further comprising:
a latch extending from the first body portion, the latch to engage the second body portion to secure the cable guide in the closed configuration.

15. The cable guide of claim 2, further comprising:
a mounting assembly removably secured to the second body portion, the mounting assembly including a pair of arms extending from a pedestal to form a cutout, the cutout to receive a portion of the structural component.

16. A method of installing a cable guide within a stud, the method comprising:
providing a cable guide with a body having a first body portion and a second body portion together defining a central opening, an arcuate surface extending from a first side of the body toward the central opening to form a lead-in radius circumferentially surrounding the opening, and a bushing on a second side of the body, the bushing projecting from the second side of the body and circumferentially surrounding the opening;
arranging the bushing through an opening in the stud so that the bushing overlaps an edge of the opening in the stud; and
guiding a cable through the central opening of the cable guide, the arcuate surface providing a snag-free surface for the cable during installation of the cable.

17. The method of claim 16, further comprising:
securing the cable guide to the stud via a magnet arranged within the second side of the body, the second side of the body in contact with a face of the stud when the cable guide is in an installed configuration.

18. The method of claim 16, wherein the arcuate surface has an arc length that is greater than a width of a spiral groove in an exterior sheath of a metal clad (MC) or armor clad (AC) cable.

19. The method of claim 16, further comprising:
if the cable is already installed through the opening in the stud prior to installation of the cable guide, moving the cable guide into an open position to permit access to the central opening via a split between the first body portion and the second body portion.

20. The method of claim 19, further comprising:
after moving the cable guide into the open position, positioning the cable within the central opening via the split between the first body portion and the second body portion; and
moving the cable guide into a closed position, with the cable arranged within the central opening of the cable guide.
